(19) United States
(12) Patent Application Publication
(10) Pub. No.: US 2015/0046881 A1
(43) Pub. Date: Feb. 12, 2015

(54) ARCHIVING BUSINESS OBJECTS

(71) Applicants: Santosh V, Bangalore (IN); Shavneet Singh, Bangalore (IN); Suvarna Kharidehal, Bangalore (IN); Antony Raja T, Bangalore (IN); Naveen K, Bangalore (IN); Maya Viswanath, Bangalore (IN); Saurabh Chaturvedi, Bangalore (IN); Premalatha Subramanian Subramanian, Salem (IN)

(72) Inventors: Santosh V, Bangalore (IN); Shavneet Singh, Bangalore (IN); Suvarna Kharidehal, Bangalore (IN); Antony Raja T, Bangalore (IN); Naveen K, Bangalore (IN); Maya Viswanath, Bangalore (IN); Saurabh Chaturvedi, Bangalore (IN); Premalatha Subramanian Subramanian, Salem (IN)

(73) Assignee: SAP AG, Walldorf (DE)

(21) Appl. No.: 13/961,420

(22) Filed: Aug. 7, 2013

(51) Int. Cl. G06F 3/0481

(52) U.S. Cl. CPC G06F 3/0481
USPC 715/853

(57) ABSTRACT

An identification of a business object may be received. Nodes of the business object may be displayed. In response to a selection of a node from the nodes, an archiving status of the node may be set. The selected node may be linked to a parent node. The selected node may be archived based on the archiving status. The nodes may be displayed in response to receiving an indication that the business object is to be partially archived. In an embodiment, the current respective archiving statuses of the nodes are displayed. In an embodiment, an identification of an archival object may be received. The archival status of the node may be saved in the identified archival object.

### BACKGROUND

Business software such as enterprise resource planning (ERP) software implements business processes by modeling business data as business objects (BOs) with data exchange between the BOs. The business data provided via BOs can be accessed through mechanisms such as graphical user interfaces (GUIs), forms, and analytical reports.

Conventional business software uses inefficient methods to archive BOs. These methods cannot handle business scenarios where first a portion of the information within a BO has to be readily available while another portion of the BO information is not accessed frequently.

### BRIEF DESCRIPTION OF THE DRAWINGS

FIG. 1 illustrates BOs according to an embodiment.

FIG. 2 illustrates a GUI to archive nodes according to an embodiment.

FIG. 3 illustrates a GUI to archive nodes according to an embodiment.

FIG. 4 illustrates processing of a BO marked for partial archiving according to an embodiment.

FIG. 5 shows an exemplary architecture according to an embodiment.

### DETAILED DESCRIPTION

Embodiments may be discussed in systems to efficiently archive BOs. In an embodiment, an identification of a business object may be received. Nodes of the business object may be displayed. In response to a selection of a node, an archiving status of the node may be set. The selected node may be linked to a parent node. The selected node may be archived based on the archiving status.

In an embodiment, the nodes may be displayed in response to receiving an indication that the business object is to be partially archived. In an embodiment, the current respective archiving statuses of the nodes may be displayed. In an embodiment, an identification of an archival object may be received. The archival status of the node may be saved in the identified archival object. In an embodiment, the identification of the business object may be received from a user via a graphical user interface. The nodes may be displayed to the user on the graphical user interface.

In an embodiment, child nodes of a node of a business object may be determined.

For each child node, an archival status of the child node may be retrieved. Upon determining that the archiving status of the child node is set, the node may be archived. Upon determining that the child node is the last child node of the node, the above steps may be repeated for each child node of the child nodes.

Business software usually includes a standard set of BOs which can be utilized by the software user to model a business entity. For example, business software may include BOs representing business entities such as sales opportunities, trade promotions, sales orders, sales quotes, customer quotes, service documents, etc. Each BO may include attributes which define metadata associated with the BO. For example, a business promotion BO may represent a business promotion offered by a first company through a second company to consumers. The first company may be a soft drink company and the second company may be a major retailer. The promotion may have a start date and an end date (a promotion period). The promotion may offer the product, for example, a soft drink, for the promotion period at a particular sale price. The business promotion BO may include attributes such as the name of the second company, the size of the second company, the type of the second company, the name of the promotion product, the sale price of the product during the promotion, the price of the product without the promotion, the quantity of the product sold during the promotion, the start date of the promotion, and the end date of the promotion.

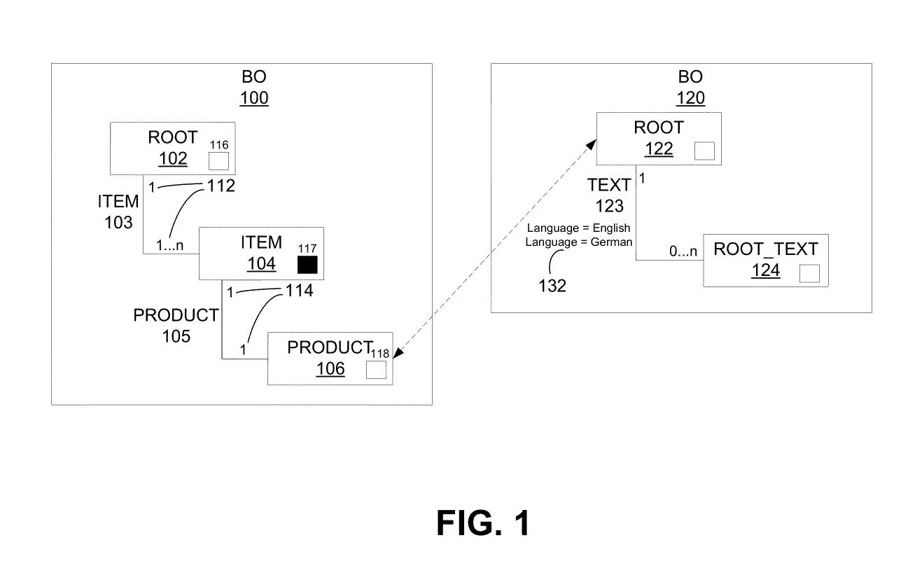

FIG. 1 illustrates BOs according to an embodiment. A BO 100 may include a collection of nodes 102, 104, and 106. Each node may include one or more attributes. For example, BO 100 may represent a sales order. The root node 102 may include attributes such as a unique identifier of the sales order (order ID) and a short description of the sales order. Each attribute may have one or more respective values. For example, the short description attribute of the root node 102 may have a value of “30 car units @ 15,000 dollars per unit” to indicate that the sales order is for 30 cars at a price of 15,000 dollars each.

A node of a BO may include other nodes under it in a hierarchy. The top level node in the hierarchy may be referred to as the root node. A node which is placed below another node in the node hierarchy may be referred to as a sub-node (or a child node) of the node.

Therefore, the “item” node 104 is a sub-node of the root node 102. The item node 104 may represent additional information pertaining to the sales order.

Two nodes may be linked through an association. The association may represent a relationship between the two nodes. For example, the item node 104 may be linked to the root node 102 via an “item” association 103. Depending on the association, one of the two nodes may be designated as the source node and the other node as the target node. In an embodiment, the parent node may be referred to as the source node and the child node may be referred to as the target node. Thus, the item association 103 may link the root node 102 (source) and the item node 104 (target).

In an embodiment, an association may link nodes belonging to different BOs. Such an association may be called a cross BO association. For example, the item node 104 in the sales order BO 100 may be associated with a product sub-node 106 via a cross BO product association 105. That is, the product node 106 may be the root node 122 which belongs to another related BO 120 (e.g., a product BO 120 representing a product from the sales order BO 100).

The cardinality of an association may specify the number of instances of the target node which can exist for an instance of the source node and vice-versa. For example, the cardinality 112 of the association between the root node 102 and the item node 104 specifies that each instance of the root node 102 may be associated with one or more item nodes 104. The cardinality 114 of the association between the item node 104 and the product node 106 (i.e., root node 122) specifies that each instance of the item node 104 must be associated with exactly one instance of a product node 106.

Associations may include parameters to enable filtering of node instances. When multiple instances of a sub-node exist for the same instance of the source node, filtering via association parameters may return only the instances of the target node for a given source node which match the filtered association parameters. For example, the root node 122 and root_text node 124 (i.e., a node which includes a textual description of the product BO 120) may have an association called “text” 123. The root_text node 124 may include an attribute called “language” to indicate the language of the text. Two root_text instances 124 may be associated with the root node instance 122. The first root_text instance may include the descriptive text in the English language and the second root_text instance may include the descriptive text in the German language. Therefore, the association, text 123, may include a language parameter 132. The language parameter may have two values, English and German, which correspond to the respective root_text node instances 124. Thus, only one matching instance of the root_text node instance 124 may be returned for a node query indicating a particular language (i.e., English or German depending on the language indicated in the query).

A BO “determination” includes BO specific logic which is executed if an internal BO event occurs. BO specific logic of determinations may be executed, for example, responsive to the creation, the deletion, or the loading of a BO instance by deriving new values for the respective BO instance's fields. For example, a determination associated with the root node 102 of the sales order may assign values to the “created_by” attribute of the root node 102 when a sales order BO instance 100 is created. The “created_by” attribute may be populated with the user name of the user who created the sales order BO instance 100.

A BO “action” is a business logic entity assigned to a BO node. Actions may modify nodes of their respective BO as well as nodes of other BOs. Actions may be triggered from an external source such as an occurrence of a business related event. For example, a “deliver” action assigned to the root node 102 of the sales order may be triggered when products belonging to the sales order are delivered to the customer. The action may be triggered in response to activation of a button on a user interface of the business software.

In an embodiment, to increase the performance of business software and to efficiently utilize computer data storage, BOs may be archived on a periodic basis based on archiving rules. An example of an archiving rule may be to archive all BOs not accessed by the business software within the last 6 months. Archiving moves data from one computer data storage to another computer data storage. The computer data storages may include one or more hard disks, memory, and/or caches. Typically, the data is moved from a faster/expensive computer data storage to a slower/less expensive computer data storage. For example, a non-archived (active) BO may be stored in one or more active database tables (expensive computer data storage). If that BO is subsequently archived, all information associated with that BO may be removed from the active database tables and copied over to an archive file and/or inactive database tables (less expensive computer data storage).

In a business example, all BOs of products which are no longer offered for sale may be archived because future transactions may not include these products. Thus, any discontinued product BO along with all the nodes and/or associations included in the BO may be archived to efficiently utilize computer data storage. A problem with this approach of archiving entire BOs, however, is that there may be business scenarios which require fast access to certain nodes and/or associations of a BO, but not others. For example, if a sales order includes multiple products, as the sales order gets partially filled, only the BOs of products which were delivered may be archived. The BOs of the undelivered products may need to remain unarchived since a range of transactions may still be performed on the undelivered products (e.g., an undelivered product may be cancelled and removed from the sales order).

To address the issue above, in an embodiment, an “archiving status” attribute may be added to the root node and sub-nodes of a BO. FIG. 1 shows the archiving status attribute as a square box within each node, e.g., 116-118. A filled box (e.g., 117) may indicate that the archiving status attribute is set (i.e., the attribute value= “archived,” indicating that the respective node is to be subsequently archived) and a non-filled box (e.g., 116 and 118) may indicate that the archiving status is not set (i.e., the attribute value= “not archived,” indicating that the respective node may not be archived). Thus, if the archiving status of a node is set, for example, via a user interface, this may indicate that the node should be archived.

In an embodiment, a third value, “partially archived,” may be set as the archiving status attribute value. If this attribute value is set for a node, it may indicate that one or more descendant nodes (i.e., child nodes, grandchild nodes, great grandchild nodes, and so on) of the node may be marked for archival (i.e., one or more descendant nodes may have an archival status value of “archived”).

In an embodiment, the root node may include a BO action associated with it which sets the value of the archiving status attribute. The BO action logic may perform relevant business checks specific to the sub-node instances and set the archiving statuses of the respective sub-node instances accordingly.

In an embodiment, the archiving status of each node may be separately set. Specifically, setting the archiving status of a node will not propagate the same archival status value to the descendants of that node. For example, setting the archiving status 116 of root 102 may indicate that only the attributes associated with that particular node 102 should be archived. The setting of archiving status 116 may not be automatically propagated to the child node 104 in this embodiment. In this embodiment, the archiving status 117 of node 104 may need to be separately set if node 104 is to be archived.

In another embodiment, setting the archiving status of a parent node may automatically indicate to the system that all descendant nodes of that parent node have to be archived. For example, if the archiving status 116 is set for root 102, in response, the archiving status 117 of item 104, and archiving status 118 of product node 106 may automatically be set (i.e., the archiving status value 116 may be copied over to the descendants). In an embodiment, the automatic propagation of the archiving status may extend to nodes in other BOs. For example, if the archiving status 118 of product 106 is set, in response, the archiving status of root 122 and root_text 124 may also be set.

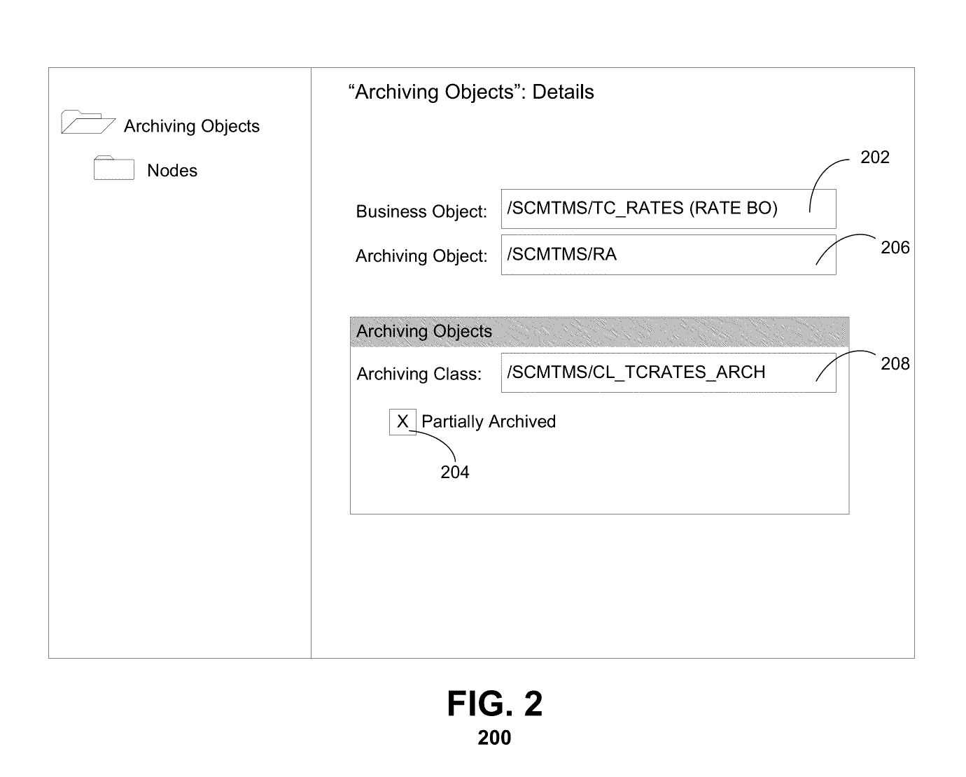

FIG. 2 illustrates a graphical user interface (GUI) 200 to archive nodes according to an embodiment. In an embodiment, the GUI 200 may be utilized to customize the archival of BOs. The GUI 200 may include an input field 202 to specify a business object for archival customization. In the example shown in FIG. 2, a rate BO is specified in input field 202. The rate BO may be related to transportation management. Specifically, the rate BO may represent the rates charged by a shipping company. The GUI 200 may include an input field 204 to specify whether the BO can be partially archived. If the user specifies that the BO can be partially archived, the sub-nodes of the BO may be archived individually based on sub-nodes' respective archiving statuses as described above.

The GUI 200 may optionally include input fields to specify additional information such as, for example, an archival object 206 which stores the settings for the customized archiving. The archival object 206 may store the settings specified via GUI 200 including the details of whether a particular BO may be partially archived. The GUI 20 may also optionally include an input field 208 to specify the archiving class of the BO. The archiving class 208 may include the software code which defines the implementation details of archiving object 206.

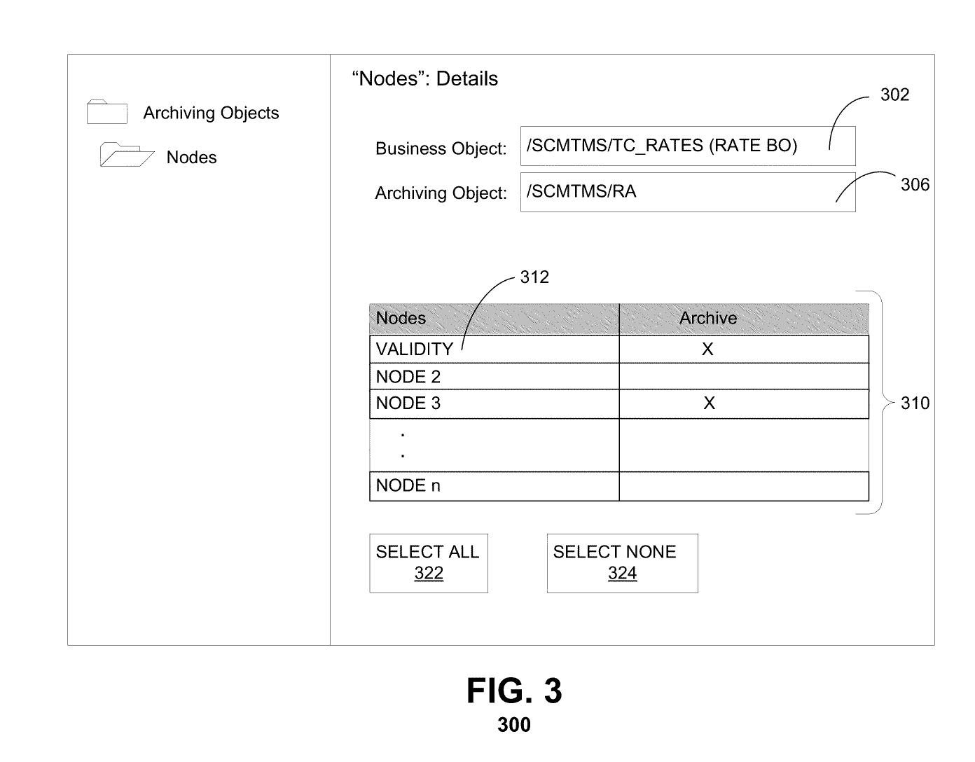

FIG. 3 illustrates a GUI 300 to archive nodes according to an embodiment. In an embodiment, the GUI 300 may be utilized by users to indicate the nodes of a BO to be archived. The GUI 300 may be displayed to the user in response to, for example, an indication by the user or the software that the BO is to be partially archived (e.g., as shown in FIG. 2 via input field 204). The GUI 300 may include an input field 302 to specify the business object. Continuing with the example in FIG. 2 above, a rate BO may be specified in input field 302. The nodes (including sub-nodes) of the BO specified in input field 302 may be displayed in viewing pane 310. From the displayed nodes, the user may identify the nodes to be archived. Each of the nodes shown in viewing pane 310 may include a respective archiving status attribute. The archiving status attribute value of each node may be set through user inputs via GUI 300.

As shown in the exemplary viewing pane 310, the “validity” node 312 may be marked by the user to be archived. The validity node may include information about the validity period of the rate represented by the rate BO specified in input field 302. In response, the archiving status of the validity node 312 may be set so that the validity node is subsequently archived. Similarly, the user may indicate other nodes of the rate BO to be archived in viewing pane 310. Although the viewing pane 312 shows the mechanism to mark a node for archival as a check box, any appropriate mechanism including highlightable rows, drop-down menus, etc. may be utilized based on the implementation details of GUI 300.

In an embodiment, the viewing pane 310 may display the nodes which have already been marked for archival previously so that the user may unmark any nodes which no longer need to be archived. In response, the archival status of the unmarked nodes may be unset so that the nodes are no longer archived.

In an embodiment, the GUI 300 may display input mechanisms 322 and 324 which allow the user to mark/unmark a batch of nodes via a single user action. For example, button 322 may allow the user to mark all nodes for archival and button 324 may allow the user to unmark all nodes.

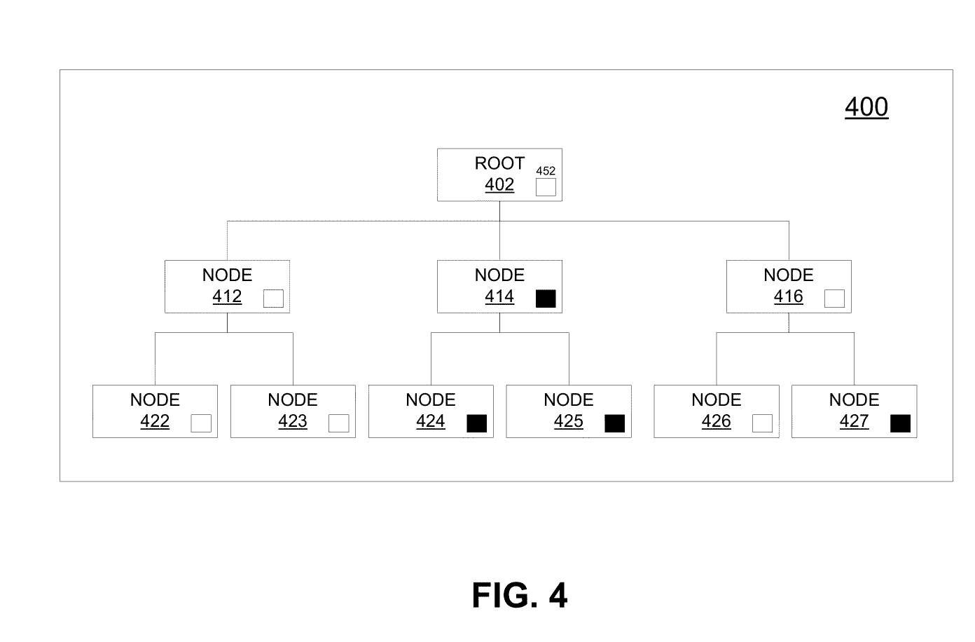

FIG. 4 illustrates processing of a BO 400 marked for partial archiving according to an embodiment. BO 400 may be marked for partial archiving via, for example, GUI 300. Each node of the BO may include an archiving status attribute shown as a square box within each node (e.g., 452). A filled box may indicate that the archiving status attribute is set (i.e., the respective node is to be subsequently archived) and a non-filled box may indicate that the archiving status is not set (i.e., the respective node is not to be archived). In an embodiment, an archiving process may traverse the nodes in the BO 400 and archive the nodes with the archiving status set. In an embodiment, the process may first check whether the root node 402's archiving status is set. Since the root node 402's archiving status is not set, the process may continue without archiving root 402. The process may then operate on the set of nodes 412-416 in the next level of the hierarchy. The process may check whether sub-node 412's archiving status is set. Since the node 412's archiving status is not set, the process may continue without archiving node 412. The process may check whether sub-node 414's archiving status is set. Since the node 414's archiving status is set, the process may archive node 414. After operating on node 416 in a similar fashion, the process may determine that there are no more nodes left in the currently processed hierarchy level. The process may then check whether more levels in the hierarchy are remaining. Thus, the process may continue to the next level with nodes 422-427. After operating on nodes 422-427, the process may determine that it has finished processing all nodes in BO 400 and may operate on any remaining BOs.

Although specific BOs are shown in some of the examples above to better explain the embodiments, these examples are illustrative and not restrictive. In other embodiments, depending on the context, different BOs may be utilized and/or processed using the principles described above.

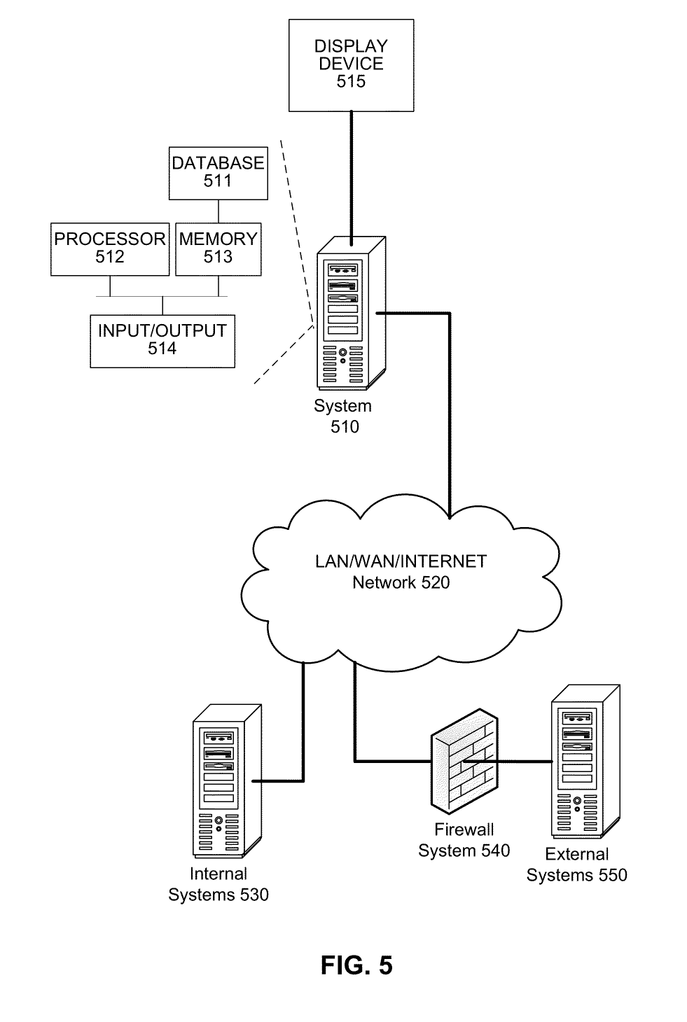

FIG. 5 shows an exemplary architecture according to an embodiment. The system running an application to view, create, or modify BOs 510 may be coupled to a display device 515, existing internal systems 530 through a network 520 and to external systems 550 through the network 520 and firewall system 540. The system running an application to view, create, or modify BOs 510 may include a desktop computer, laptop computer, tablet PC, client computer, mobile phone, central computer in a vehicle, wearable computer such as Google Glass™, any device with a touch screen, and any other computer. The display device 515 may include a computer monitor, a touch screen, a tablet PC screen, a mobile phone screen, a heads-up display (HUD), and any other displays. The existing internal systems 530 may include a server and may provide business data and/or other data. The external systems 550 may include a server and may be maintained by a third party, such as an information service provider, and may contain business data and/or other data, that may be updated by the third party on a periodic basis. The system running an application to view, create, or modify BOs 510 may interact with these external systems to obtain updates through a firewall system 540 separating the internal systems from the external systems.

A person having ordinary skill in the art will appreciate that while internal systems 530 and external systems 550 are included in FIG. 5, in some embodiments, one or both of these systems may not be required. In an embodiment, the functionality provided by the internal systems 530 and external systems 550 may be provided by the system running the application to view, create, or modify BOs 510.

Each of the systems in FIG. 5 may contain a processing device 512, memory 513, a database 511, and an input/output interface 514, all of which may be interconnected via a system bus. In various embodiments, each of the systems 510, 530, 540, and 550 may have an architecture with modular hardware and/or software systems that include additional and/or different systems communicating through one or more networks. The modular design may enable a business to add, exchange, and upgrade systems, including using systems from different vendors in some embodiments. Because of the highly customized nature of these systems, different embodiments may have different types, quantities, and configurations of systems depending on the environment and organizational demands.

In an embodiment, memory 513 may contain different components for retrieving, presenting, changing, and saving data. Memory 513 may include a variety of memory devices, for example, Dynamic Random Access Memory (DRAM), Static RAM (SRAM), flash memory, cache memory, and other memory devices. Additionally, for example, memory 513 and processing device(s) 512 may be distributed across several different computers that collectively comprise a system.

Database 511 may include any type of data storage adapted to searching and retrieval. The database 511 may include SAP database (SAP DB), Informix, Oracle, DB2, Sybase, and other such database systems. The database 511 may include SAP's HANA (high performance analytic appliance) in-memory computing engine and other such in-memory databases.

Processing device 512 may perform computation and control functions of a system and comprises a suitable central processing unit (CPU). Processing device 512 may comprise a single integrated circuit, such as a microprocessing device, or may comprise any suitable number of integrated circuit devices and/or circuit boards working in cooperation to accomplish the functions of a processing device. Processing device 512 may execute computer programs, such as object-oriented computer programs, within memory 513.

The foregoing description has been presented for purposes of illustration and description. It is not exhaustive and does not limit embodiments of the invention to the precise forms disclosed. Modifications and variations are possible in light of the above teachings or may be acquired from the practicing embodiments consistent with the invention. For example, some of the described embodiments may include software and hardware, but some systems and methods consistent with the present invention may be implemented in software or hardware alone. Additionally, although aspects of the present invention are described as being stored in memory, this may include other computer readable media, such as secondary storage devices, for example, solid state drives, or DVD ROM; the Internet or other propagation medium; or other forms of RAM or ROM.

We claim:

1. A computer-implemented method comprising:
receiving an identification of a business object;
displaying nodes of the business object; and
in response to a selection of a node from the nodes, setting an archiving status of the node, wherein the selected node is linked to a parent node and the selected node is archived based on the archiving status.

2. The method of claim 1, wherein the nodes are displayed in response to receiving an indication that the business object is to be partially archived.

3. The method of claim 1, wherein the current respective archiving statuses of the nodes are displayed.

4. The method of claim 1, further comprising:
receiving an identification of an archival object; and
saving the archival status of the node in the identified archival object.

5. The method of claim 1, wherein the identification of the business object is received from a user via a graphical user interface and the nodes are displayed to the user on the graphical user interface.

6. A computer-implemented method comprising:
(a) determining child nodes of a node of a business object;
(b) for each child node:
retrieving an archival status of the each child node,
upon determining that the archiving status of the each child node is set, archiving the node, and
upon determining the each child node is a last child node of the node, iteratively repeating steps (a) and (b) for every child node from the child nodes.

7. An apparatus comprising:
a processor to:
receive an identification of a business object;
display nodes of the business object; and
in response to a selection of a node from the nodes, set an archiving status of the node, wherein the selected node is linked to a parent node and the selected node is archived based on the archiving status.

8. The apparatus of claim 7, wherein the nodes are displayed in response to receiving an indication that the business object is to be partially archived.

9. The apparatus of claim 7, wherein the current respective archiving statuses of the nodes are displayed.

10. The apparatus of claim 7, wherein the processor is further configured to:
receive an identification of an archival object; and
save the archival status of the node in the identified archival object.

11. The apparatus of claim 7, wherein the identification of the business object is received from a user via a graphical user interface and the nodes are displayed to the user on the graphical user interface.

12. An apparatus comprising:
a processor to:
(a) determine child nodes of a node of a business object;
(b) for each child node:
retrieve an archival status of the each child node,
upon determining that the archiving status of the each child node is set, archive the node, and
upon determining the each child node is a last child node of the node, iteratively repeat steps (a) and (b) for every child node from the child nodes.

13. A non-transitory computer-readable medium embodied with computer-executable instructions for causing a computer to execute instructions, the computer instructions comprising:
receiving an identification of a business object;
displaying nodes of the business object; and
in response to a selection of a node from the nodes, setting an archiving status of the node, wherein the selected node is linked to a parent node and the selected node is archived based on the archiving status.

14. The computer-readable medium of claim 13, wherein the nodes are displayed in response to receiving an indication that the business object is to be partially archived.

15. The computer-readable medium of claim 13, wherein the current respective archiving statuses of the nodes are displayed.

16. The computer-readable medium of claim 13, further comprising:
receiving an identification of an archival object; and
saving the archival status of the node in the identified archival object.

17. The computer-readable medium of claim 13, wherein the identification of the business object is received from a user via a graphical user interface and the nodes are displayed to the user on the graphical user interface.

18. A non-transitory computer-readable medium embodied with computer-executable instructions for causing a computer to execute instructions, the computer instructions comprising:
(a) determining child nodes of a node of a business object;
(b) for each child node:
retrieving an archival status of the each child node,
upon determining that the archiving status of the each child node is set, archiving the node, and
upon determining the each child node is a last child node of the node, iteratively repeating steps (a) and (b) for every child node from the child nodes.

19. A computer-implemented method comprising:
receiving an identification of a business object via a graphical user interface;
receiving an identification of an archival object via the graphical user interface;
displaying nodes of the business object on the graphical user interface, wherein the nodes are displayed in response to receiving an indication that the business object is to be partially archived;
in response to a selection of a node from the nodes, setting an archiving status of the node, wherein the selected node is linked to a parent node and the selected node is archived based on the archiving status; and
saving the archiving status of the node in the identified archival object.
